(19) United States
(12) Patent Application Publication
(10) Pub. No.: US 2007/0046103 A1
(43) Pub. Date: Mar. 1, 2007

(54) System for distributing AC power wthin an equipment rack

(76) Inventors: Christian L. Belady, McKinney, TX (US); Bradley D. Winick, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/586,929

(22) Filed: Oct. 26, 2006

Related U.S. Application Data
(63) Continuation-in-part of application No. 11/179,920, filed on Jul. 12, 2005.

(51) Int. Cl. H02J 1/08; H02J 3/00

(52) U.S. Cl. 307/12; 307/13

(57) ABSTRACT

Systems, methods, and apparatus are disclosed for supplying power to racks having plural servers. One exemplary embodiment is a system with a rack having a plurality of servers and being connected to two separate alternating current (AC) power grids that distribute power to the plurality of servers with load of the rack being distributed across both AC power grids.

### CROSS-REFERENCE TO RELATED APPLICATION

This application is a continuation-in-part of U.S. Ser. No. 11/179,920, filed on Jul. 12, 2005 entitled “System for Distributing AC Power within an Equipment Rack.”

### BACKGROUND

As datacenters have increased in size and complexity, the number and variety of computer equipment rack configurations used in datacenters has also increased. This variety has brought with it an equally diverse set of alternating current (AC) power requirements. Each rack configuration may require different voltages (e.g., 120V, 208V, 220, and 240V), as well as different power phase configurations (e.g., single-phase and Delta or Wye three-phase). The power cabling to each rack may also differ based on these requirements. If upgrades are made later to the devices installed within a rack, it may be necessary to change the power cabling providing power to the rack, due to changes in the power requirements of the new devices.

Differences and changes in power requirements not only may affect how power is provided to each rack within a datacenter, but may also have similar effects on the how power is distributed within each of the racks. Different devices within a rack may have different power requirements, necessitating different power cables and connectors within the rack. As requirements change and devices are upgraded or replaced, it may become necessary to change the wiring and/or connectors that connect the devices to the power distribution system within a rack.

### BRIEF DESCRIPTION OF THE DRAWINGS

For a detailed description of exemplary embodiments of the invention, reference will now be made to the accompanying drawings in which:

FIG. 1 shows a block diagram of an equipment rack comprising a power distribution system constructed in accordance with at least some embodiments.

FIG. 2A shows a connector pair configured for single-phase, 120V AC operation, usable in a power distribution system constructed in accordance with at least some embodiments.

FIG. 2B shows a connector pair configured for three-phase, 208V AC operation, usable in a power distribution system constructed in accordance with at least some embodiments.

FIG. 3 shows an equipment rack comprising a power distribution system constructed in accordance with at least some embodiments.

FIG. 4 shows a phase-balancing wiring scheme usable in a power distribution system constructed in accordance with at least some embodiments.

FIG. 5 shows part of a datacenter comprising a plurality of racks, each comprising a power distribution system constructed in accordance with at least some embodiments.

FIG. 6A shows an exemplary datacenter with plural racks in accordance with at least some embodiments.

FIG. 6B shows another exemplary datacenter with plural racks in accordance with at least some embodiments.

FIG. 7 shows an exemplary flow diagram for sharing power with multiple power supplies in a datacenter in accordance with at least some embodiments.

### NOTATION AND NOMENCLATURE

Certain terms are used throughout the following description and claims to refer to particular system components. As one skilled in the art will appreciate, computer companies or data centers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. Further, the term “system” refers to a collection of two or more parts and may be used to refer to a power distribution system or a portion of a power distribution system.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Equipment racks provide not only mechanical support for the devices installed within them, but also the electrical power necessary to operate the devices within them. A variety of configurations are used to provide power, comprising different voltages (e.g., 380V, 240V, 208V, 200V and 120V) and different combinations of phases (e.g., single-phase and 3-phase). If the power requirements of one or more installed devices changes, some configurations avoid the need to alter or rewire either the cabling connecting power to the rack, or the power distribution cabling within the rack.

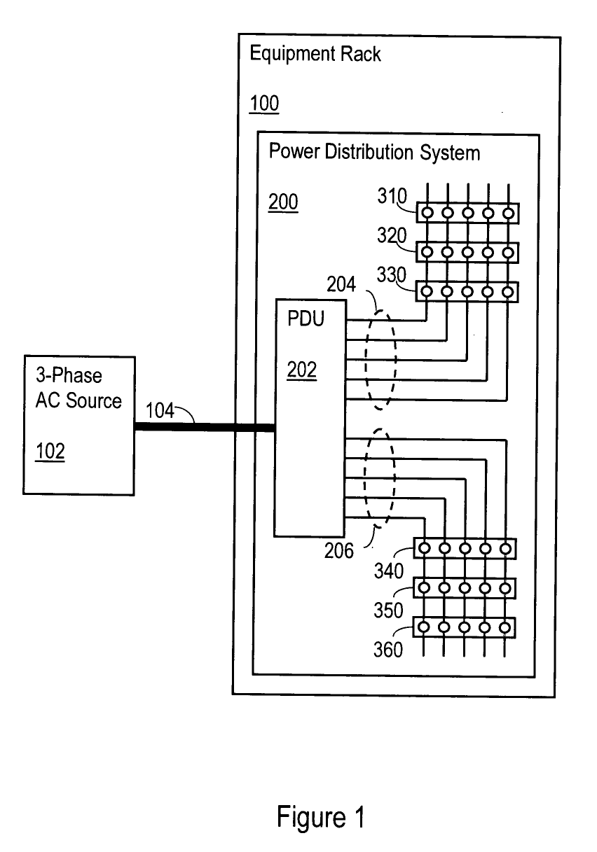

FIG. 1 illustrates a block diagram of a power distribution system 200 incorporated into an equipment rack 100. A 3-phase alternating current (AC) power source 102 provides power to the equipment rack 100 using a 5-conductor cable 104. Three of the conductors provide AC power at a nominal level of 120 volts RMS with respect to a fourth neutral conductor, each conductor carrying one of three phases, and each phase nominally 120 degrees out of phase with each other. The fifth conductor of the cable 104 provides a protective earth path. Cable 104 couples to power distribution unit (PDU) 202 within the power distribution system 200 of equipment rack 100. PDU 202 may be used to provide a number of functions, such as fusing, branching, isolation, and surge protection, to name a few examples. In the embodiment of FIG. 1, for example, the PDU 202 branches the main power feed from cable 104 into two separate circuits 204 and 206. Additional PDUs (not shown) may be added to provide more branches, or to provide redundant power when coupled to additional redundant power feeds.

Each of the branched circuits 204 and 206 couple to a plurality of rack-mounted connectors 310-360. These rack-mounted connectors 310-360 make all three phases (plus the neutral and earth ground paths) available to any device that is installed in the rack. A device installed in the rack may comprise a device-mounted connector that mates to a rack-mounted connector. The mated connectors couple the installed device to one of the branched circuits (i.e., branched circuit 204 or 206). The device-mounted connector may be configured to select one, two, or all three phases, depending on the power requirements of the installed device. By using rack-mounted connectors with a fixed configuration in concert with configurable device-mounted connectors, changes in the power requirements of the device may be accommodated without changing the wiring of either of the branched circuits 204 and 206, or the cable 104.

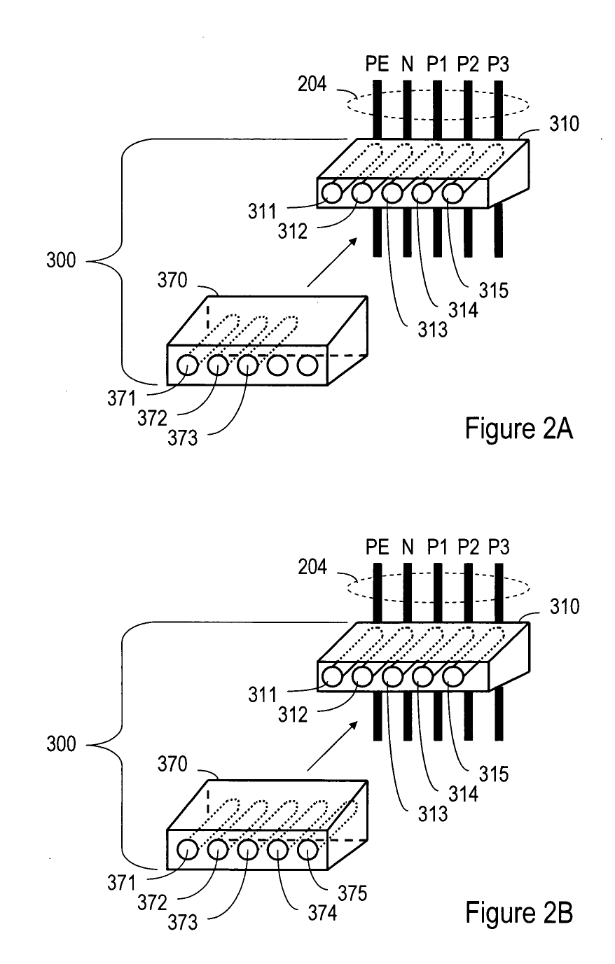

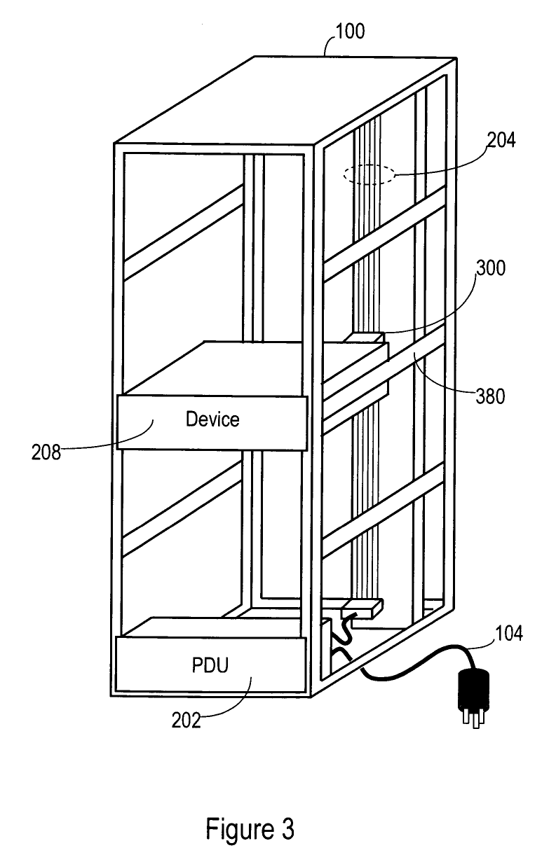

FIG. 2A illustrates a rack-mounted/device-mounted connector pair 300 constructed in accordance with at least some embodiments. The rack-mounted connector 310 mounts within equipment rack 100 and comprises a plurality of sockets 311 through 315, each mounted within the rack-mounted connector 310. In the example shown, each pin couples to a conductor within branched circuit 204. In some embodiments, branched circuit 204 comprises five conductors: phase 1 (P1), phase 2 (P2), phase 3 (P3), a neutral (N), and a protective earth (PE). The device-mounted connector 370 mounts to a device (such as one of more servers 208 mounted in equipment rack 100 of FIG. 3). Continuing to refer to FIG. 2, the device-mounted connector 370 is adapted to mate with the rack-mounted connector 310, and comprises pins coupled to conductors (not shown) that provide power to the device. The number of pins within device-mounted connector 370, however, is configurable and may vary depending on the power requirements of the device. The device-mounted connector 370 shown in FIG. 2A, for example, comprises three pins 371 through 373. When the device-mounted connector mates with the rack-mounted connector as shown, pins 371, 372 and 373 couple a protective earth, a neutral, and phase 1 to the device. The example shown in FIG. 2A would thus result in providing single-phase 120V RMS AC power to the device.

Connectors 310 and 370 can couple to each in a variety of ways. The figures show a pin and socket coupling wherein pins 371, 372, etc. are received within corresponding sockets 311, 312, etc. Embodiments in accordance with the present invention, though, are not limited to a pin and socket connection. For example, other male-female connectors are possible. Further, connector 310 can include the male connectors while connector 370 includes the female connectors. In other embodiments, connector 310 includes the female connectors while connector 370 includes the male connectors.

In the embodiment illustrated in FIG. 2B the rack-mounted connector 310 is configured in the same manner as in FIG. 2A, but the device-mounted connector 370 is configured differently and provides an illustrative three-phase 208V RMS AC power to the device. In this configuration, pins 371, 372, 373, 374, and 375 couple the protective earth, the neutral, phase 1, phase 2, and phase 3 respectively to device. As illustrated in FIGS. 2A and 2B, the configuration of the device-mounted connector 370 thus determines how power is provided to the device. Changes in the power requirements of the device may be accommodated without altering the internal configuration of the rack 100 (e.g., the configuration of PDU 202 or the branched circuit 204 of FIG. 1), and without altering how power is provided to the equipment rack 100 (e.g., without alterations to the power source 102 or the cable 104 of FIG. 1, such as having 380 VAC and connecting phase to neutral to get 220 VAC).

The device-mounted connector 370 of FIG. 2 may be mounted to the device such that it mates with rack-mounted connector 310 when the device is mounted in equipment rack 100. Referring now to FIG. 3, mating may be accomplished, for example, by a combination of guide rails 380, and a rack-mounted/device-mounted connector pair 300. The guide rails 380 position the device 208 such that it can be inserted from the front of the equipment rack 100 and slid along the guide rails 380 towards the back of the equipment rack 100. As the device approaches the end of travel along the guide rails 380, the equipment-mounted half of connector 300 begins to mate with the rack-mounted half of connector 300 (coupled to branched circuit 204). At the end of travel along the guide rails 380 the two connector halves are fully mated. Once fully mated, power provided via cable 104, through PDU 202 and through branched bus 204 may be used to operate device 208. Other embodiments (not shown) may include additional branched circuits and connectors similar to branched circuit 204 and connector 300. Such additional branched circuits and connectors may provide additional or redundant power that may also be used to operate device 208.

The connector halves of connector 300 may thus be “blind-mated” or coupled to each other without the need to see them and manually align them. The positioning of the connector halves of connector 300, as well as the positioning of the guide rails 380, provides the necessary alignment to ensure proper mating. Tapered connector housings (as shown in FIGS. 2A and 2B) may also be used to allow for some error in alignment. Other mounting and mating systems may become apparent to those skilled in the art, and this disclosure is intended to encompass all such variations. For example, a device 208 that does not incorporate the device-mounted connector 370 of FIG. 2 may instead use an adaptor cable (not shown) to couple the device 208 to the rack-mounted connector 310.

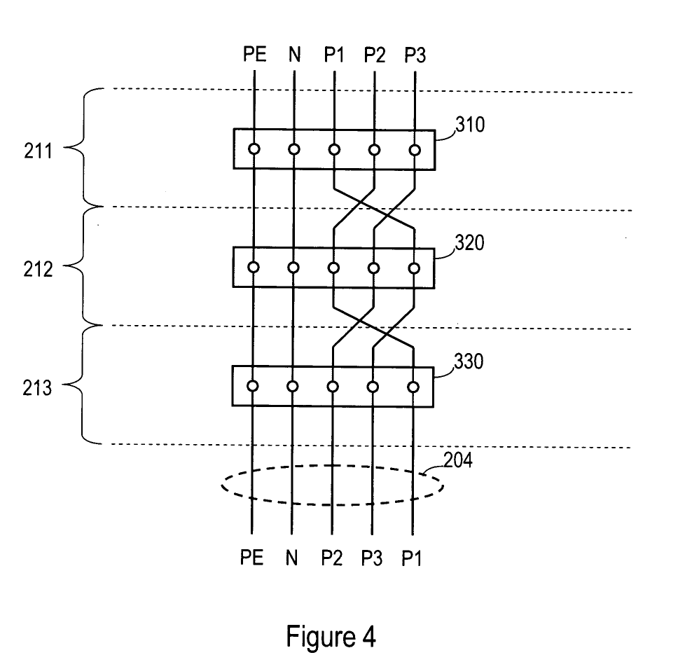

The power distribution system 200 of the equipment rack 100 may also be configured so as to provide the capability of load-balancing the various phases of the multi-phase power distributed within the rack 100. FIG. 4 illustrates a 3-phase load-balancing configuration in accordance with at least some embodiments. Three rack-mounted connectors 310 through 330 are shown coupled to branched circuit 204. Each rack-mounted connector is positioned at a different rack elevation levels (levels 211 through 213). The protective earth and neutral wires are coupled to the same pins on all three rack-mounted connectors, but the three phases (P1, P2, and P3) are each wired on different connector pins of a connector, for a given rack elevation level, than the pins of a connector mounted at an immediately adjacent elevation level. Thus, phase 2 couples to the center pin of the connector at rack elevation level 212, but is not coupled to the center pin of adjacent connectors 211 and 213. If, for example, a device that requires single-phase 120V power and uses a device-mounted connector that is configured to use a single power phase on the center pin, the device will use phase 1 when installed at rack elevation level 211, phase 2 when installed at rack elevation level 212, and phase 3 when installed at rack elevation level 213. Thus, if the device is installed at all three rack elevation levels, each using a single phase on pin 3, the total electrical load of the installed device will be distributed among the three phases of the 3-phase AC power provided. Other ordering schemes that distribute the loading of the various phases may become apparent to those skilled in the art, and this disclosure is intended to encompass all such variations.

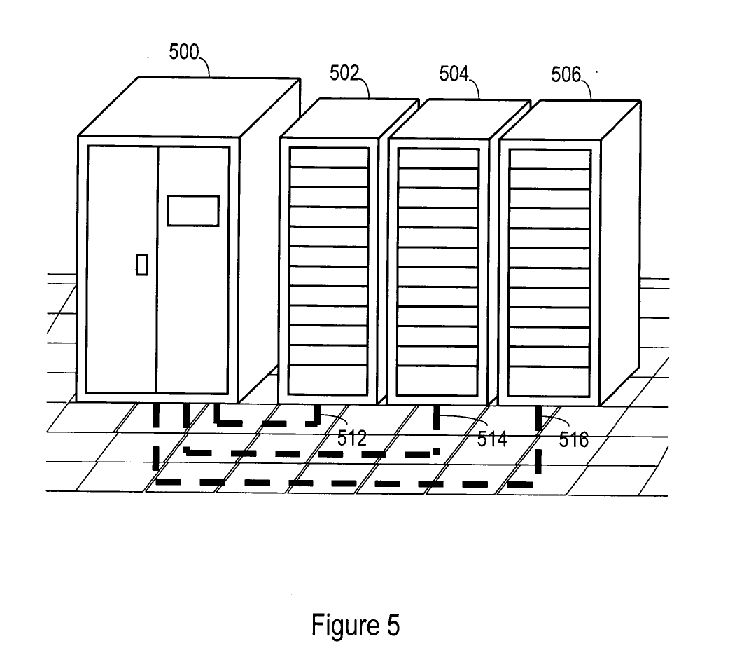

FIG. 5 illustrates a plurality of racks within a datacenter, each comprising a power distribution system 200. The power feed from the 3-phase AC power source 500 comprises the same configuration for each rack. In the example of FIG. 5, the racks 502, 504, and 506 each couple to the 3-phase AC power source 500 via power cables 512, 514, and 516 respectively. These cables each comprise 5 conductors which comprise three phases (1, 2, and 3), a neutral path, and a protective earth path. Because each cable is configured in the same manner and provides each of the racks 502 through 506 with power in the same way, the overall cabling of the data center is simplified. Since the individual racks can each accommodate a variety of power requirements by changing the configuration of a device-mounted connector, device upgrades and expansions may be possible within each of the racks 502 through 506 without modifying the power cables 512 through 516. Other embodiments (not shown) may also include additional power sources and power cables that may be used to provide additional or redundant power to each of the racks 502 through 506.

Numerous variations and modifications will become apparent to those skilled in the art once the above disclosure is fully appreciated. For example, although the embodiments shown receive power from a 3-phase, 208-volt source, other embodiments may use sources comprising a different number of phases, different phase configurations, and different operating voltages. These embodiments may comprise Delta or Wye phase configurations such as those used in the United States, Europe and Japan, and may be configured to accommodate any or all of these phase configurations and operating voltages. Further, any number of PDUs may be installed in an equipment rack, and such installation may comprise locations at any elevation at the front, back, or along the sides of the rack.

In one exemplary embodiment, the datacenter provides dual AC power paths to installed equipment and maintains system power even during disruption to a primary power source. Thus, the datacenter eliminates all single points of power failure and enables isolation of a single power system (example, for testing or maintenance) without affecting power supply to any of the racks or other equipment in the datacenter.

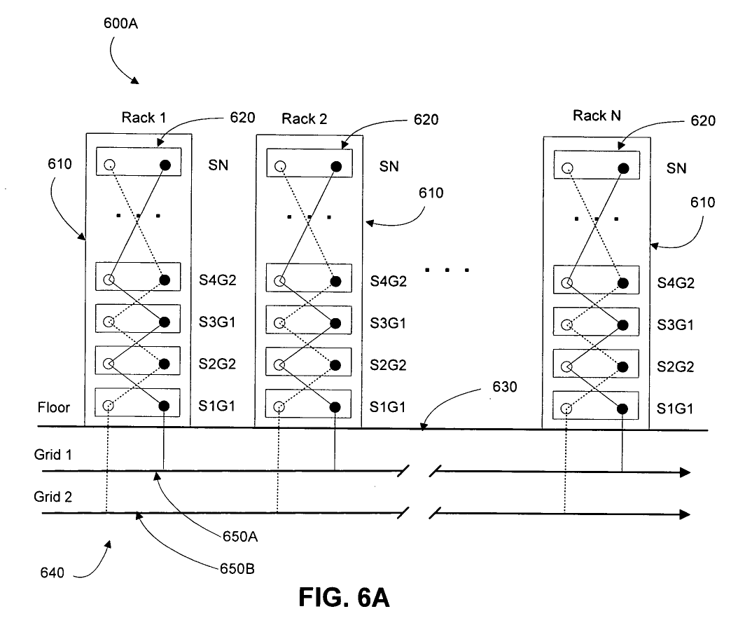

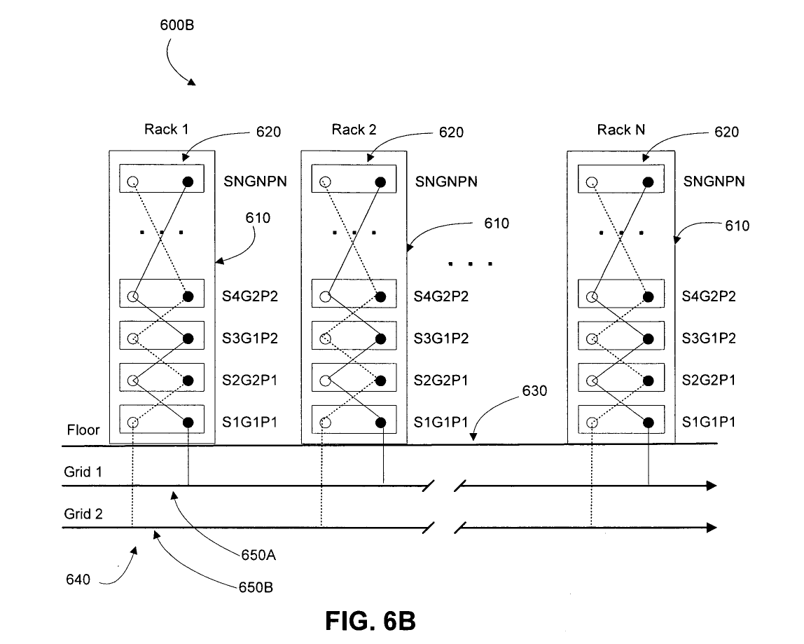

FIG. 6A shows an exemplary datacenter 600A in accordance with an embodiment of the present invention. The datacenter 600A includes one or more racks 610 (shown as rack 1, rack 2, to rack N). Each rack includes one or more electronic devices or servers 620 (shown as S1, S2, S-N) vertically stacked inside the rack.

The datacenter 600A is situated in a building or room that has a floor 630 and an electrical system 640. The electrical system includes a multiple grid power system that includes a first AC power supply 650A (shown as Grid 1) and second AC power supply 650B (shown as Grid 2).Grid 1 is shown with a solid line and Grid 2 is shown with a dotted line to indicate that the two grids do not short each other. By way of example, Grid 1 is a primary power supply and Grid 2 is a backup or generation power supply. As another example, each grid is connected to an independent breaker system having dedicated circuit boxes. As another example, each grid is powered from different and separate substations. Thus, the AC power supplies can be separate and independent of each other. Further, for convenience of illustration, the electrical system 640 is shown adjacent the floor, but one skilled in the art appreciates that this system can be located in various places, such as, but not limited to, the ceiling, the walls, on top of the floor, underground, etc. Further yet, the electrical system is shown with two power supplies or dual power grids, but any number of multiple power grids can supply power (including AC and DC power) to the datacenter. By way of example, the grids include any one or more of three-phase AC, single-phase AC, 380 VCD, +48 VDC, −48 VDC, or any other voltage possibility.

In one exemplary embodiment, the electrical system 640 provides redundant, fault tolerant power. For example, if one or more of the grid lines 650A or 650B fails, needs serviced, or otherwise shuts-down, then the racks 610 continue to receive uninterrupted power.

As shown, each rack receives power from each grid line. Power from both grids is evenly distributed across the loads for each of the racks and/or the entire load for the datacenter. In one exemplary embodiment, each grid line supplies power to alternating servers in order to distribute load evenly across both grid lines. By way of example, a first server (S1) in rack 1 receives power from Grid 1 (G1); the second server (S2) in rack 1 receives power from Grid 2 (G2); the third server (S3) in rack 1 receives power from Grid 1 (G1); etc. The primary point of power being shown with a darkened circle at a server, and a secondary or alternate point of power being shown with a non-darkened circle at a server. In this manner, the load for each rack is evenly distributed across plural, separate, independent power supplies. Thus, load is balanced across the power system and within each rack since load is shared between two different power grids. For example, a balanced load occurs if all servers in a rack are single-phase and powered from alternating or randomly selected grids.

In exemplary embodiments, the servers are single-phase devices, multiple phase devices, or both. Thus, each rack can include one or more of both single and multiple phase devices. Further, in exemplary embodiments that utilize three-phase servers, the phase can be alternating within alternating or randomly connected grids as well.

In one exemplary embodiment, each server is coupled to power from each power grid. In one embodiment, Grid 1 exclusively provides power to every other (i.e., alternating) servers in the rack; and Grid 2 provides back-up power to these alternating servers. At the same time, Grid 2 exclusively provides power to every other (i.e., alternating) servers in the rack not being powered by Grid 1; and Grid 1 provides back-up power to these alternating servers. Thus, both grids connect to each server. In another embodiment, Grid 1 and Grid 2 both supply power to every server in the rack. Here, load is shared between Grid 1 and Grid 2. For example, each grid shares approximately fifty percent of the load for each server and/or approximately fifty percent of the load for the datacenter. In yet another embodiment, Grid 1 and Grid 2 are randomly connected to servers throughout the datacenter. This random connection ensures that power is evenly distributed over the entire datacenter. Of course, even if servers do not have redundant capability, load can still be evenly distributed across the datacenter by alternating or randomly connecting servers to the grids.

FIG. 6B shows an exemplary datacenter 600B in accordance with another embodiment of the present invention. The datacenter 600B includes one or more racks 610 (shown as rack 1, rack 2, to rack N). Each rack includes one or more electronic devices or servers 620 (shown as S1, S2, S-N) vertically stacked inside the rack. The datacenter 600B of FIG. 6B has some similarities with datacenter 600A of FIG. 6A (with some common reference numerals existing between both figures).

In one exemplary embodiment, the electrical system 640 of FIG. 6B provides redundant, fault tolerant power for servers (S1 to SN) that utilize three-phase power. As shown, each rack receives power from each grid line. Power from both grids is evenly distributed across the loads for each of the racks and/or the entire load for the datacenter. Further, power for each grid is evenly distributed across the three phases within each rack. In one exemplary embodiment, the servers are randomly connected to Grid 1 and Grid to provide an overall balance load across the entire datacenter. In another exemplary embodiment, each grid line supplies three-phase power to alternating servers in order to distribute load evenly across both grid lines. By way of example, a first server (S1) in rack 1 receives power from Grid 1 (G1) and phase 1 (P1); the second server (S2) in rack 1 receives power from Grid 2 (G2) and phase 1 (P1); the third server (S3) in rack 1 receives power from Grid 1 (G1) and phase 2 (P2); the fourth server (S4) in rack 1 receives power from Grid 2 (G2) and phase 2 (P2); etc. In this manner, the load for each rack is evenly distributed across plural, separate, independent phases for each power supply. Thus, load for three-phases is balanced across the power system and within each rack since load is equally shared across the three phases between two different power grids.

The datacenter can accommodate both low-voltage input (such as 100 to 120 VAC) and high-voltage input (such as 200 to 240 VAC). In one exemplary embodiment, the servers in the rack or PDUs have sensing circuitry to automatically adjust to the applied input voltage.

In one exemplary embodiment, each rack includes one or more PDUs (example, see PDU 202 in FIG. 1). The PDU is configured to minimize the effects of ground-leakage currents, inrush currents or short-circuit currents and overload current events that occur in the rack. The number and type of PDUs varies according to datacenter and server design criteria. By way of example, if twenty-one separate servers are stacked in the rack, the servers could require up to 8,560 volt-amperes (VA) to operate. If two 24-A PDUs at 208 V have a limit of 10,000 VA, then two PDUs are sufficient to handle the load of the servers. If power redundancy is desired, then the rack has four 24-A PDUs.

In one exemplary embodiment, the servers and PDUs are modular (or modules) and thus movable and replaceable within a rack. A modular PDU integrates outlets, wire, and breakers in a single unit on each rack. By way of example, 16 A to 40 A PDUs can have 32 outlet receptacles. Further, each PDU can include a fault-tolerant dual input that automatically switches from one grid to another grid (example, primary input source to a secondary input source) in the event of a power failure.

The datacenter uses single phase-power, three-phase power, or both. Generally, power into the datacenter is stepped-down to 480 V or less. Equipment or devices that operate on single-phase current (i.e., single-phase loads) are connected to one of the single-phase power sources (example, to one phase winding of a transformer and its neutral connection). Equipment or devices that operate on three-phase current (i.e., three-phase loads) are connected to one of the three-phase power sources (example, to three windings of the transformer and its neutral connection). As one example, the datacenter uses a 208-V power three-phase system, such as high-line AC power that operates with 208 V between any two transformer windings.

The racks have various configurations and sizes depending on the needs of the datacenter. In one exemplary embodiment, the racks have a height from about 70 inches and 87 inches and hold from six 8U servers to about forty-two 1U servers. As used herein, “U” is a standard unit of measure that denotes the vertical usable space or height of the racks, cabinets, or other enclosure for holding servers. 1U is equal to 1.75 inches. For example, a rack designated as 20 U, has 20 rack spaces for equipment and has 35 (20 ×1.75.) inches of vertical usable space. Rack and cabinet spaces and the equipment which fit into them are all measured in U.

In one exemplary embodiment, each rack provides redundant power to one or more of the servers in the rack. In one embodiment, redundant power is designated as N+N, where the first digit is the number of power supplies needed to support the power configuration of the server and the second digit is the number of online spares. In a 1+1 configuration, a single power source supplies power to the server and a second, separate power source provides redundancy. Both supplies can be simultaneously on to deliver fifty percent of the power needed to distribute the load across both supplies. In a 2+1 configuration, the server is provided with three power supplies, two power supplies are used to power the device (example, assuming use of low voltage power) and the third power supply is used for redundancy. If any one of the three power supplies fails, the server continues to run on the two remaining power supplies. Alternatively, all three power supplies are energized to deliver power such that each supply delivers approximately thirty three percent of the power needed by the system. If one power supply fails, then the remaining two supplies each provide fifty percent of the needed power.

In one exemplary embodiment, the redundant power supplies share load. Thus, a 1+1 redundant power system is configured to that during normal power usage, each power supply, PDUs, and distribution lines utilize fifty percent of the load. In other words, at the rack level, each PDU provides fifty percent of the load for the rack. At the server level, each power supply provides fifty percent of the load. When a failure occurs (example, one of the power feeds goes down), the full load is supplied with the one remaining power supply.

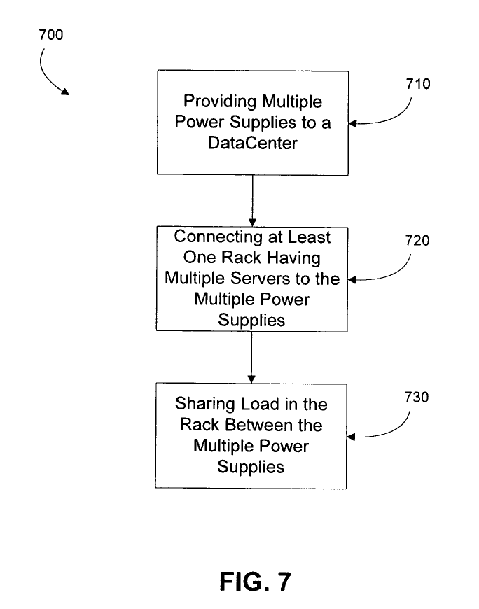

FIG. 7 shows an exemplary flow diagram 700 for sharing power with multiple power supplies in a datacenter in accordance with an exemplary embodiment. According to block 710, multiple power supplies are provided to a datacenter. By way of example, the multiple power supplies are separate, independent power supplies (such as a different grid or transmission lines) that enable redundant or fault tolerant power to be provided to the datacenter.

According to block 720, at least one rack having multiple servers in the datacenter is connected to at least two of the power supplies of the multiple power supplies. By way of example, one of more PDUs in a single rack connects to multiple power supplies. By way of example, one or more PDUs 202 (shown in FIG. 3) are used.

According to block 730, load in the rack is shared between the multiple power supplies. Exemplary embodiments include sharing load with single-phase and three-phase servers and systems. By way of example, FIGS. 6A and 6B show examples for sharing load between multiple servers in multiple racks within a datacenter.

As used herein, the term “module” means a unit, package, or functional assembly of electronic components for use with other electronic assemblies or electronic components. A module may be an independently-operable unit that is part of a total or larger electronic structure or device. Further, the module may be independently connectable and independently removable from the total or larger electronic structure (such as a PDU being modular and removable from a rack in a datacenter).

While the invention has been disclosed with respect to a limited number of embodiments, those skilled in the art will appreciate, upon reading this disclosure, numerous modifications and variations. It is intended that the appended claims cover such modifications and variations and fall within the true spirit and scope of the invention.

What is claimed is:

1) A system, comprising:
a rack having a plurality of servers and being connected to two separate alternating current (AC) power grids that distribute power to the plurality of servers with load of the rack being distributed across both AC power grids.

2) The system of claim 1 wherein the servers are vertically stacked in the rack with a first server being powered from one power grid and a second server being powered from another power grid.

3) The system of claim 1, wherein each AC power grid supplies power to every other server in the rack.

4) The system of claim 1, wherein the plurality of servers are vertically stacked and the load is evenly shared between both AC power grids.

5) The system of claim 1, wherein the AC power grids include a first power grid supplying power to a first half of the plurality of servers and a second power grid supplying power to a second half of the plurality of servers.

6) The system of claim 1, wherein power is distributed to the plurality of servers such that a first server receives power only from a first power grid, a second server receives power only from a second power grid, a third server receives power only from the first power grid, and a fifth server receives power only from the second power grid.

7) The system of claim 1, wherein the AC power grids provide redundant power to the rack and supply power to alternating servers in the rack in order to distribute the load evenly across the AC power grids.

8) A method, comprising:
connecting a rack having plural servers to multiple AC power grids; and
evenly distributing load of the plural servers between the multiple AC power grids.

9) The method of claim 8 further comprising:
supplying power to alternating stacked servers such that every other server receives power from a same one of the multiple AC power grids.

10) The method of claim 8 further comprising:
providing three-phase power to each of the plural servers such that each of the multiple AC power grids only supplies power to every other server.

11) The method of claim 8 further comprising:
evenly distributing three-phase power to the plural servers with the multiple AC power grids.

12) The method of claim 8 further comprising:
stacking the plural servers in a vertical stack in the rack;
supplying fifty percent of required load to each of the plural servers with each of two of the multiple AC power grids.

13) A system, comprising:
plural computer racks, each computer rack (1) having plural vertically stacked servers and (2) receiving power from two alternating current (AC) power grids such that load from the plural computer racks is shared between the two AC power grids.

14) The system of claim 13, wherein the servers comprise both single-phase devices and three-phase devices.

15) The system of claim 13, wherein each of the two AC power grids supplies power to every other server in a rack.

16) The system of claim 13, wherein each of the two AC power grids supplies half of required power to every server in a rack.

17) The system of claim 13, wherein the load is evenly distributed between the two AC power grids.

18) The system of claim 13, wherein the two AC power grids are independent of each other and supply redundant power to the racks such that failure of one of the AC power grids will not cause a disruption of power being supplied to the racks.

19) The system of claim 13, wherein a first one of the two AC power grids supplies power to every other server and a second one of the two AC power grids supplies power to remaining servers not supplied with power from the first one of the two AC power grids.

20) The system of claim 13, wherein each of the two AC power grids supplies the racks with half of the load, and each server receives power from both AC power grids in a N+N configuration.
